(19) United States
(12) Patent Application Publication
(10) Pub. No.: US 2007/0203729 A1
(43) Pub. Date: Aug. 30, 2007

(54) MEDIA BUYING SYSTEM FOR PLACEMENT ON DIGITAL MESSAGING DEVICES

(75) Inventors: Frederic A. MacDonald, Santa Monica, CA (US); Joel Hladecek, Van Nuys, CA (US)

Correspondence Address: MCGUIREWOODS, LLP, 1750 TYSONS BLVD, SUITE 1800, MCLEAN, VA, 22102, US

(73) Assignee: MODstream LLC.

(21) Appl. No.: 11/675,465

(22) Filed: Feb. 15, 2007

Related U.S. Application Data
(60) Provisional application No. 60/773,321, filed on Feb. 15, 2006.

(51) Int. Cl. G06Q 10/00

(52) U.S. Cl. 705/1; 705/14

(57) ABSTRACT

A process for selling or auctioning digital advertising includes the steps of assembling ad placement criteria into discrete advertising packages that are of unique benefit to advertisers. Setting prices for advertising packages that will be viewable online. Enabling an electronic bidding process which concludes in a winner. A selection of advertising package criteria will be customizable by the advertiser, customizing select advertising package criteria to result in an automated modification of its price, selling advertising packages at a reasonable time before the Message is to be published, allowing advertisers a specified amount of time to submit their message for approval, entering the message into a web interface, to allow the advertiser to choose desired Line Dwell-Time and Transitions between Lines, electronically notifying once an advertiser's message has been approved. The digital advertising may be published on a shopping cart based device, retail based device, or food tray based device

### CROSS-REFERENCE TO RELATED APPLICATIONS

This application claims priority under 35 U.S.C. §119(e) to provisional U.S. patent application Ser. No. 60/773,321, filed on Feb. 15, 2006, the disclosure of which is expressly incorporated by reference herein in its entirety.

### BACKGROUND OF THE INVENTION

1. Field of the Invention

The invention is directed to a system and process for selling digital advertising.

2. Related Art

Currently, digital advertising is sold through normal channels of this service industry at set or negotiated prices. This price does not always reflect the demand for the type of advertising, location of advertising, time of advertising, and the like.

Accordingly, there is a need for a system and process to sell digital messaging more effectively.

### SUMMARY OF THE INVENTION

The invention meets the foregoing need and allows more effective digital messaging sales, which results in a significant increase in sales and/or profits and other advantages apparent from the discussion herein.

The invention may be implemented in a number of ways. According to one aspect of the invention includes a process for selling digital advertising having the steps of setting prices for advertising packages that are viewable online, customizing select advertising package criteria to result in an automated modification of its price, selling advertising packages at a reasonable time before the message is to be published, and electronically notifying once an advertiser's message has been approved.

The process may further include allowing advertisers a specified amount of time to submit their message for approval. The process may further include entering the message into a web interface to allow the advertiser to choose desired line dwell-time and transitions between lines. The process may further include publishing the digital advertising on at least one of a shopping cart based device, retail based device, and food tray based device.

According to another aspect of the invention a process for auctioning digital advertising includes the steps of setting minimum bid prices for advertising packages that are viewable online, allowing advertisers to place bids on advertising packages, setting a time limit resulting in a conclusion of auction, and identifying a winning bid.

The winning bid may be the highest bid at conclusion of auction. The process may further include allowing winners a specified amount of time to submit their message for approval. The process may further include entering the message into a web interface to allow the winner to choose desired line dwell-time and transitions between lines. The process may further include electronically notifying once a winner's message has been approved. The process may further include auctioning advertising packages of identical criteria in sequence. The process may further include auctioning dissimilar advertising packages simultaneously. The process may further include auctioning advertising packages at a reasonable time before the message is to be published. The process may further include publishing the digital advertising on at least one of a shopping cart based device, retail based device, and food tray based device.

A system for selling digital advertising may have at least one computer processing and use the above-noted method. A system for auctioning digital advertising may have at least one computer processing the above-noted method.

In yet another aspect of the invention a system for selling digital advertising in the form of discrete advertising packages has the steps of identifying specific typographic or psychographic profiles that advertisers try to reach, assembling place(s) and time(s) criteria that aligns with behaviors of individuals with the specific typographic or psychographic profiles, listing advertising packages of place(s) and time(s) criteria for sale under recognizable names, and selling advertising packages under the above-noted method. The process may further include publishing the digital advertising on at least one of a shopping cart based device, retail based device, and food tray based device.

Another aspect of the invention is directed to a system for selling digital advertising in the form of discrete advertising packages having the steps of identifying specific typographic or psychographic profiles that advertisers try to reach, assembling place(s) and time(s) criteria that aligns with behaviors of individuals with the specific typographic or psychographic profiles, listing advertising packages of place(s) and time(s) criteria for sale under recognizable names, and selling advertising packages under the above-noted method. The process may further include publishing the digital advertising on at least one of a shopping cart based device, retail based device, and food tray based device.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows operational steps of the system constructed according to the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

Overview

One component of the invention is an automated clearinghouse that may allow advertisers or other message buyers to purchase, or place bids in auctions on specific time slots, geographic locations, retail chains, or combinations of these and other criteria in discrete groups that will be referred to herein as advertising packages. In the case of auctions, the highest bidding advertiser may “win” the auction, allowing the advertiser to have its message displayed on the respective applications at the respective time(s) and place(s).

Applications for advertising packages may include wireless, digital-data display devices that may be attached to shopping carts in a physical retail location such that a shopper who pushes one of the carts may view wirelessly-delivered digital messages on the device's screen. Another application for advertising packages may include wireless, digital-data display devices that may be attached to food service articles (including but not limited to food trays) in a restaurant such that a customer who uses one of the trays to transport food to a table may also view messages on the device's screen.

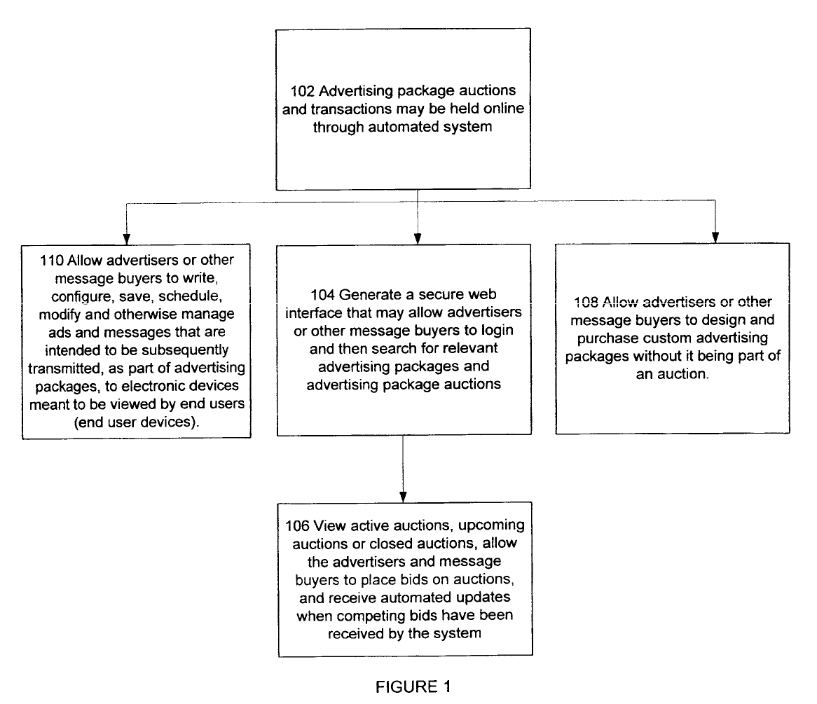

As shown in FIG. 1, the advertising package auctions and transactions may be held online through a largely automated system 102 designed for this purpose and may include a secure web interface that may allow advertisers or other message buyers to login and then search for relevant advertising packages and advertising package auctions 104 and, among other activities, view active auctions, upcoming auctions or closed auctions, allow the advertisers and message buyers to place bids on auctions, and receive automated updates when competing bids have been received by the system 106. This system may also allow advertisers or other message buyers to design and purchase custom advertising packages without it being part of an auction 108. Additionally, the system may allow advertisers or other message buyers to write, configure, save, schedule, modify and otherwise manage ads and messages that are intended to be subsequently transmitted, as part of advertising packages, to electronic devices meant to be viewed by end users (end user devices) 110. In short, this secure, web-based, automated system may support all of the primary interaction and transacting required to allow advertisers or message buyers to buy or bid on advertising packages, and to create and put ads or messages into the associated applications in venues where retail and restaurant customers can view them.

### Definitions/Description

END USER DEVICE—An End User Device may be any electronic device that is configured to receive messages or ads as part of ad packages and to display them to end users.

MESSAGE/AD—At any time an end user device may hold a plurality of “Messages” (or Ads) in its memory chip. A Message is one complete idea, or advertisement, for example “Today only, save 10% on Product X!”

LINE—By way of example., some end user devices may display up to 40 characters at any instant including blank spaces—this is called a “Line”. A Message writer may choose to make use of less than the full 40 characters, and if so, the rest of the screen may be left blank- this may still be considered one Line. A Line may be a complete Message, or may be a portion of a Message that may be made up of additional Lines in a sequential order.

It should be noted that Lines may eventually include logos, images, video, audio and much more than 40 characters per Line, and at such time, Messages may no longer require the convention of Lines at all. In that case Messages may be considered whole units that have a discrete duration.

LINE DURATION—End user devices may display Lines- one at a time- for an average of about 2.5 seconds each; this may be longer or shorter depending on the complexity, or importance of the Line, and may be based on average reading speeds. This amount of time is called the Line Duration.

MESSAGE DURATION—With each Line of each Message lasting an average of about 2.5 seconds, the sum of the Line Durations for all the Lines in a Message is the Message Duration.

LOOP—Eventually all the Messages meant to be displayed in the memory chip may have been displayed, and at this time the plurality of Messages may repeat continuously in the same order. This complete plurality of Messages in memory is called a “Loop.”

LOOP DURATION—With each Line of each Message lasting an average of about 2.5 seconds, an entire loop lasts as long as it takes all the Messages in a Loop to be displayed. This amount of time is called the Loop Duration.

In most cases, Loops will be made up of Messages that come from a variety of sources. The Retailers whose carts may be outfitted with end user devices may generate a percentage of the Messages in a Loop. Other Messages may be inserted into the Loop by the Advertising Auctioning System.

ADVERTISING PACKAGES—An advertiser who wishes to place a message on end user devices may do so through the automated system in one of two ways: by purchasing advertising packages or by placing winning bids on advertising packages. Advertising packages are compositions of ad-message-locations and times that make up a discrete schedule for a message. Among the criteria that may impact the composition of advertising packages are:

MESSAGE LIFE (overall, how long a message will live from birth to expiration):
Months of the year
Weeks of the Month
Days of the week
Time of day

MESSAGE SCHEDULE (when the message is to be included in a Loop during its life):
All day, every day
Weekdays
Weekends
Specific days
Specific hours of the day
Specific hours of specific clays

MESSAGE FREQUENCY (how often the message repeats in the loop):
Once
More than once (low, medium, high frequency)
Continuously (the ONLY message in the Loop)

LINE DWELL-TIME (How long a Message's Lines stay on screen):
<2 Seconds
2 Seconds
2.5 Seconds
3 Seconds
>3 Seconds

LOCATION:
Country
Regions
States
Cities
Neighborhoods
Stores
Aisles

RETAILERS:
Grocery Retailers
Hardware Retailers
Big Box Retailers
Discount Retailers
Home Improvement Retailers
Department Retailers
Office Supply Retailers
Pet Supply Retailers
Toy Retailers
Fast Food Restaurants
etc

From these possible criteria, advertising packages are generated that are targeted for the convenience of bidding advertisers. The following are just a couple examples of possible advertising packages compositions:

1. “Stay At Home Mom—Kids In School. GROCERY. NATIONAL. JULY. MEDIUM FREQUENCY”

This advertising packages may go out to all the Grocery Retailers that have end user devices attached to their shopping carts and the message may be part of those loops for one month- in this case July. It may further display the Message on Weekdays between the hours of 8AM and 3PM (during typical school hours when the “Stay at home mom” has time to shop) and might display the Message 3 times over the course of the Loop. The maximum number of Lines allowed in the Message will be two.

2. “Business Professional OFFICE SUPPLY. PACIFIC, Jul. 10, 2006 3-HOUR SPECIAL”

This advertising packages would go out to all the Office Supply Retailers that have end user devices attached to their shopping carts in the Pacific Region only, and only on Monday Jul. 10, 2006. Further it may be displayed from 6AM to 9AM, and again from 6PM to 9PM. This would probably be used by an advertiser as a special savings promotion to take advantage of those times when business professionals might have time to shop. The maximum number of Lines allowed in the Message will be two.

In each of these examples you will notice that the advertising package has been designed around a typographic or psychographic such that it may typically address types of audiences that advertisers try to reach. There may be many, many more advertising package descriptions that advertisers may browse.

Additionally, it may be possible for advertisers to customize some of these criteria to suit the specific needs of a campaign or promotion. And there may be limits; a limit may be imposed on Line Dwell Time, and the number of Lines a Message may be composed of for example, but an advertiser may choose to increase this number to some larger maximum limit, by paying an additional fee.

Purchase

In one model, sale prices may be set for select advertising packages that may be viewable online. A selection of advertising package criteria may be customizable by the advertiser. Customization of select advertising package criteria may result in an automated modification of its price.

Advertising packages may be put on sale at a reasonable time before the Message is to be published. In some cases this could be Months, Weeks, or Days before, depending on the composition of the specific advertising package, and any approval limitations that may be imposed by participating Retailers

Advertisers may then have a specified amount of time to submit their message for approval. The message may be entered into a web interface, which may also allow the advertiser to choose desired Line Dwell-Time and Transitions between Lines. As stated, increased Line Dwell-Time may result in a fee.

Once an advertiser's message has been approved, the winner may be notified electronically.

Auctions

Typically, a limited quantity of advertising packages of a common type may be available for auction. For the purposes of this description, let's say there are a total of six “Stay At Home Mom—Kids In School” advertising packages available for the month of July. Each of these six then, may be auctioned in sequence, one at a time. In other words, only after the timer has run down on the auction for the first of the six, and a winner determined, may the second go up for auction. This may apply only to advertising packages of a common type. There may be many simultaneous auctions running at once- but each auction may represent a different type, or composition.

Auctions may be conducted within a reasonable time before the Message is to be published. In some cases this could be Months, Weeks, or Days before, depending on the composition of the specific advertising package, and any approval limitations that may be imposed by participating Retailers. This lead-time, auction duration, and any other schedule-oriented deadlines may be standard policy.

A web-based interface may allow registered advertisers to browse advertising packages and place bids. Among other things, this interface may show:
time remaining in the auction,
remaining quantity of like advertising packages,
current high-bid,
estimated length of Loop,
and a full description of the message schedule.

As in any auction, the highest bidder at the end of the auction may win the advertising package, and be responsible for payment, and message submission/approval, before their message may be entered into the cue in preparation for being added to the published Loop at the assigned times.

At this time if any auction goes “un-bid” the related advertising package may simply be discarded, as opposed to attempting to “re auction” it later. This may have the effect of raising the perceived value of any remaining advertising packages of that type, as it may result in shorter Loops, and therefore more repetition of those messages that do get published.

Once the auction is closed, and the winner awarded, the winner may have a specified amount of time to submit their message for approval. The message may be entered into a web interface, which may also allow the advertiser to choose desired transitions between Lines.

Once a winner's message has been approved, the winner may be notified electronically.

The invention may be employed with a cart device described in U.S. patent application Ser. No. 10/757,577, filed Jan. 15, 2004 by Frederic Macdonald, Joel Hladecek, Norman DeCost, Scott Keller, and Donald C. Miffitt titled Passive display unit and system and method of use, that published as United States Patent Publication No: US 2004-0192399 on Sep. 30, 2004; or Passive Display Unit and System and Method of Use described in U.S. patent application Ser. No. 11/549,407, filed Oct. 13, 2006 by Frederic Macdonald, Joel Hladecek, and Norman DeCost, titled Integrated Material Handing and Displaying Unit, System, and Method of Use both incorporated by reference herein in their entireties.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A process for selling digital advertising comprising the steps of:
setting prices for advertising packages that are viewable online;
customizing select advertising package criteria to result in an automated modification of its price;
selling advertising packages at a reasonable time before the message is to be published; and
electronically notifying once an advertiser's message has been approved.

2. The process for selling digital advertising according to claim 1 further comprising the step of:
allowing advertisers a specified amount of time to submit their message for approval.

3. The process for selling digital advertising according to claim 1 further comprising the step of:
entering the message into a web interface to allow the advertiser to choose desired line dwell-time and transitions between lines.

4. A process for auctioning digital advertising comprising the steps of:
setting minimum bid prices, for advertising packages that are viewable online;
allowing advertisers to place bids on advertising packages;
setting a time limit resulting in a conclusion of auction; and
identifying a winning bid.

5. The process for auctioning digital advertising according to claim 4 wherein the winning bid comprises the highest bid at conclusion of auction.

6. The process for auctioning digital advertising according to claim 4 further comprising the step of:
allowing winners a specified amount of time to submit their message for approval.

7. The process for auctioning digital advertising according to claim 4 further comprising the step of:
entering the message into a web interface to allow the winner to choose desired line dwell-time and transitions between lines.

8. The process for auctioning digital advertising according to claim 4 further comprising the step of:
electronically notifying once a winner's message has been approved.

9. The process for auctioning digital advertising according to claim 4 further comprising the step of:
auctioning advertising packages of identical criteria in sequence.

10. The process for auctioning digital advertising according to claim 4 further comprising the step of:
auctioning dissimilar advertising packages simultaneously.

11. The process for auctioning digital advertising according to claim 4 further comprising the step of:
auctioning advertising packages at a reasonable time before the message is to be published.

12. A system for selling digital advertising comprising at least one computer processing the method of claim 1.

13. A system for auctioning digital advertising comprising at least one computer processing the method of claim 4.

14. A system for selling digital advertising in the form of discrete advertising packages comprising the steps of:
identifying specific typographic or psychographic profiles that advertisers try to reach;
assembling place(s) and time(s) criteria that aligns with behaviors of individuals with the specific typographic or psychographic profiles;
listing advertising packages of place(s) and time(s) criteria for sale under recognizable names; and
selling advertising packages under the method of claim 1.

15. A system for selling digital advertising in the form of discrete advertising packages comprising the steps of:
identifying specific typographic or psychographic profiles that advertisers try to reach;
assembling place(s) and time(s) criteria that aligns with behaviors of individuals with the specific typographic or psychographic profiles;
listing advertising packages of place(s) and time(s) criteria for sale under recognizable names; and
selling advertising packages under the method of claim 4.

16. The process for selling digital advertising according to claim 1 further comprising the step of:
publishing the digital advertising on at least one of a shopping cart based device, retail based device, and food tray based device.

17. The process for selling digital advertising according to claim 4 further comprising the step of:
publishing the digital advertising on at least one of a shopping cart based device, retail based device, and food tray based device.

18. The process for selling digital advertising according to claim 14 further comprising the step of:
publishing the digital advertising on at least one of a shopping cart based device, retail based device, and food tray based device.

19. The process for selling digital advertising according to claim 15 further comprising the step of:
publishing the digital advertising on at least one of a shopping cart based device, retail based device, and food tray based device.
